(19) United States
(12) Patent Application Publication
(10) Pub. No.: US 2007/0140482 A1
(43) Pub. Date: Jun. 21, 2007

(54) Method for storing data in a random access memory and encryption and decryption device

(76) Inventors: Hagen Ploog, Hamburg (DE); Reinhard Steffens, Munich (DE)

Correspondence Address: O'SHEA, GETZ & KOSAKOWSKI, P.C., 1500 MAIN ST., SUITE 912, SPRINGFIELD, MA, 01115, US

(21) Appl. No.: 10/577,005

(22) PCT Filed: Nov. 3, 2004
(86) PCT No.: PCT/EP04/12435

§ 371 Date: Jul. 5, 2006

(30) Foreign Application Priority Data
Nov. 10, 2003 (DE) 103 52 401.0

(51) Int. Cl. H04L 9/00

(52) U.S. Cl. 380/44

(57) ABSTRACT

The invention relates to a method of storing data in a random access memory and to an encryption and decryption device. According to the method of storing data in a random access memory in which data words, each comprising a predetermined number of data bits, are storable, an encryption of each data word is effected before storage whereby a permutated data word with a predetermined number of data bits is generated from each data word, or from a data word derived from this data word, by one-to-one permutation of the individual data bits using a first permutation key.

### PRIORITY INFORMATION

This application claims priority from International application PCT/EP2004/012435, filed Nov. 3, 2004 and German application 103 52 401.0, filed Nov. 10, 2003.

### BACKGROUND OF THE INVENTION

This invention relates in general to data security and in particular to storing data in a random access memory.

To ensure data security or to protect copyrights with respect to data stored in memory, a known approach is to store the data in encrypted form in a read-only memory (ROM), such as, for example, an EPROM, EEPROM, CD-ROM, or DVD-ROM. These data may relate to both data from executable programs (program codes) as well as video or audio data. An approach is also known where video data or audio data are transmitted in encrypted form from a transmitting device to a receiving device. The use of the encryption-stored or encryption-transmitted data is thereby theoretically enabled only for those users who have a corresponding decryption unit (decoder) with a “matching” key.

Conventional encryption algorithms, such as, for example, the DES method (Data Encryption Standard) or the AES method (Advanced Encryption Standard) encrypt/encode the data blockwise, where with the DES method, for example, 64 data bits are encoded in one block. Since in the DES method the number of data bits contained in a data block is usually greater than the number of data bits of a data word capable of being processed by a processing unit, it is necessary to have the processing unit first store the data words obtained after decoding a data block in a random access memory (RAM) before these data words undergo further processing.

The RAM located externally to the processing unit represents a security risk insofar as there is a possibility that the encrypted data can be tapped along the link between the RAM and the processing unit. These data, for example video or audio data, can then be stored in unencrypted form, thereby making them accessible to unauthorized use.

If the data stored in the RAM are the data of a program code, then there is the risk that the program flow may be determined by unauthorized persons. In addition, there is the risk that unauthorized program code may be fed into the unit executing the program, for example, to provide additional functions not intended to be provided by the authorized program code.

What is needed is a relatively secure technique of storing data in a RAM which does not have the aforementioned disadvantages and is implementable at relatively low cost, as well as a device to encrypt and decrypt the data stored in a RAM.

### SUMMARY OF THE INVENTION

Briefly, according to an aspect of the invention, a method for storing data in a random access memory (RAM) in which data words are storable with a predetermined number of data bits, involves an encryption of each data word before storage in the RAM, where a permutated data word with a predetermined number of data bits is generated from each data word or from a data word derived therefrom, by a one-to-one rearrangement or permutation of the individual data bits using a first permutation key.

The individual data bits of the permutated data word are substituted using a first substitution key before storage, where the data word encrypted by permutation and subsequent substitution is stored in the RAM. There is also the possibility of substituting the data bits of the data word to be encrypted before the permutation using a first substitution key, and of storing the data word obtained from the substitution and subsequent permutation as the encrypted data word.

The encryption of the individual data words is preferably performed in the same chip in which the processing unit that processes the data words is integrated. The data words transferred externally from this chip to the RAM for storage are provided in encrypted form, and are thus protected against interference effects or unauthorized tapping of the data. The encryption is performed data word by data word, with the result that, unlike the case of blockwise encryption, no additional storage on the chip is required for encryption or decryption.

The permutation or rearrangement of the individual data bits as determined by the permutation key represents an effective encryption method. Given a data word width of 32 bits, there are 32!≈2.6·10³⁵ different permutation possibilities. This number of permutation possibilities for a data word of 32 bit width increases by a factor of 2³² when in addition to the permutation a substitution of the input data word, or of the already permutated data word, is performed using a substitution key of 32 bit width.

The substitution of a data word is performed as determined by the substitution key, for example, by assigning a key bit of the substitution key to each data bit of the data word, where the respective data bit is mapped, in unchanged or inverted form as a function of the value of the assigned substitution key bit, to the data word resulting from the substitution.

In one embodiment, the permutation key comprises a number of unique subkeys corresponding to the number of the data bits of the data word to be permutated, these keys each being assigned to a data bit of the data word resulting from the permutation. The individual subkeys indicate which of the data bits of the data word to be permutated is to be mapped to the respective data bit to which the subkey is assigned.

Each subkey of the permutation key comprises a number of key bits, where preferably provision is made to implement incrementally the mapping of a data bit of the data word to be permutated to a data bit of the permutated data word using a subkey according to the following steps:

a) selecting a first group of data bits from the data bits of the permutated data word as determined by a first key bit of the subkey;

b) selecting a second group of data bits from the first group of data bits obtained by the previous selection as determined by a second key bit of the subkey; and

c) repeating step b), each time using an additional key bit to select from the group obtained by the previous selection an additional group until the selected group comprises only one more data bit which corresponds to the data bit of the permutated data word.

This type of incremental selection procedure to map a data bit of the data word to be permutated to a data bit of the permutated data word provides the advantage that no storage elements are required for implementation.

The permutation key, and possibly the substitution key, are regenerated before a new writing to the RAM, for example, after connection to a device containing the RAM.

The substitution key, which comprises a number of substitution key bits corresponding to the number of data bits, may be generated by picking out a corresponding number of bits from a sequence supplied by a random number generator.

When generating the permutation key, the individual subkeys preferably differ to ensure a one-to-one assignment of a data bit of the data word to be permutated to a data bit of the permutated data word. To generate the individual sub-permutation-keys which are each assigned to a bit position of the permutated data word, and which together yield the permutation key, provision is made to generate a sub-permutation-key consecutively for each bit position of the permutated data word, and thereby to check whether the generated sub-permutation-key has already been generated for another bit position. If this sub-permutation-key has already been generated, it is rejected and a new sub-permutation-key is randomly generated for the given bit position. If the randomly generated sub-permutation-key does not yet exist, then this key is retained for the given bit position. This procedure repeats until for each bit position of the permutated data word one sub-permutation-key has been assigned for the selection of a data bit of the data word to be permutated.

The decryption of the data words stored in the RAM is effected analogously to the encryption procedure. If in a two-step procedure comprising permutation and substitution the data word to be encrypted is first permutated and then substituted, then during decryption the encrypted data word is first “back”-substituted using a second substitution key to undo the substitution effected during encryption, and subsequently “back”-permutated using a second permutation key to undo the permutation effected during the encryption.

If during encryption of the data word first a substitution and then a permutation are performed, then during decryption the encrypted data word is first permutated using the second permutation key, then substituted to recover the original data word.

Depending on the type of substitution used, the first substitution key can be selected in identical form to the second substitution key, for example, whenever the substitution comprises the mapping of the individual data bits unchanged or inverted as determined by the key bits of the substitution key. These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a block diagram illustration of an encryption and decryption unit which encrypts the data to be stored in a RAM and which decrypts the data read out from the RAM;

FIG. 2 is a block diagram illustration of the encryption and decryption unit of FIG. 1; FIG. 3 is a block diagram illustration of the encryption unit of FIG. 2;

FIG. 4 is a block diagram illustration of the permutation unit of FIG. 3;

FIG. 5 is a block diagram illustration of one of the selection units of the permutation unit of FIG. 4;

FIG. 6 illustrates the functional principle of the selection unit of FIG. 5 for a data word of 8 bit width;

FIG. 7 is a block diagram illustration of one of the selection switches of the selection unit of FIG. 5;

FIG. 8 is a block diagram illustration of the substitution unit of FIG. 3;

FIG. 9 is a block diagram illustration of one of the substitution elements of the substitution unit of FIG. 8;

FIG. 10 illustrates the construction of the permutation key from subkeys and key bits, and the construction of the substitution key;

FIG. 11 is a block diagram illustration of a permutation unit of FIG. 2 for use in encrypting a data word of four bits;

FIG. 12 is a block diagram illustration of a permutation unit of FIG. 2 for use in decrypting a data word of four bits; and

FIG. 13 is a block diagram illustration of an internal memory provided in the key generator that stores a first permutation key for the encryption of FIG. 11 and a second permutation key for the decryption of FIG. 12.

### DETAILED DESCRIPTION OF THE INVENTION

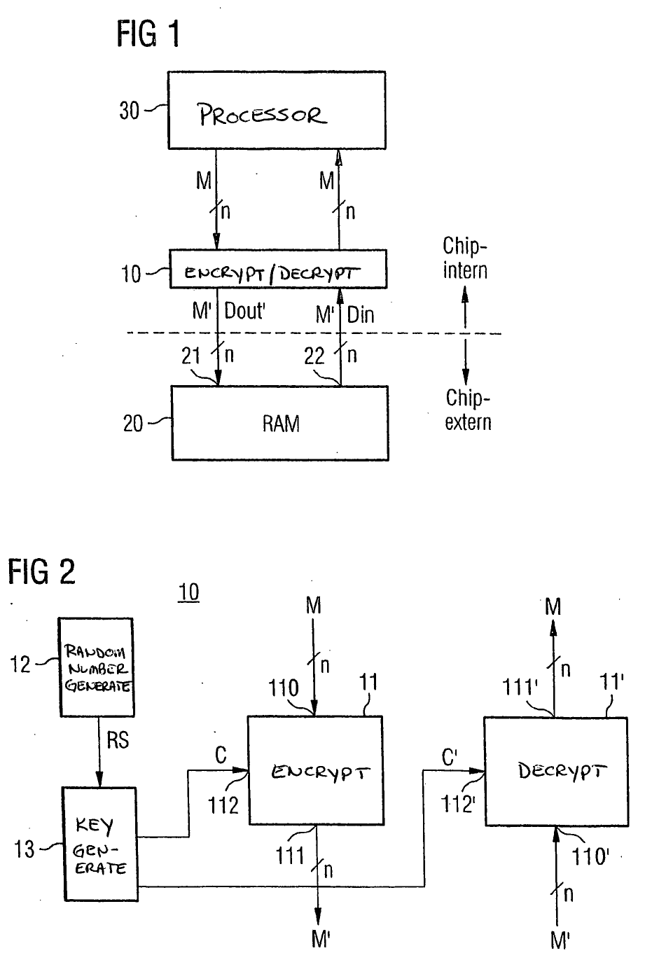

Unless otherwise indicated, like reference numerals designate corresponding components and signals throughout the different views. FIG. 1 illustrates a random access memory (RAM) 20 which stores data words of n-bit width. The RAM 20 has an input 21 to read in data words to be stored, and an output 22 to read out stored data words. Not illustrated in FIG. 1 are the well-known required control wires through which the memory addresses are communicated to the RAM 20, at which addresses the individual data words are to be stored or from which addresses the individual data words are to be read out.

Processing of the data words read into or out of the RAM 20 is performed in a data processing unit 30, for example, a processor. Depending on the type of the processor 30, the data words stored in the RAM 20 are, for example, data words of a program code which is executed by the processor 30, or data words of video or audio data which are moved by the processor 30 through suitable output units for playback.

The data processing unit 30 and the RAM 20 are not integrated on a common chip or integrated circuit (“IC”), as indicated in FIG. 1 by the broken line between the data processing unit 30 and the RAM 20. To prevent any “wiretapping” of or interference with data communication between the data processing unit 30 and the RAM 20, an encryption and decryption unit 10 is provided between the data processing unit 30 and the RAM 20 on the same chip on which the data processing unit 30 is located. The encryption/decryption unit 10 encrypts data words M outputted by the data processing unit 30 to provide encrypted data words M′ which are stored word-by-word in the RAM 20. In the reverse direction, the encryption/decryption unit 10 decrypts the data words M′ stored in encrypted form in the RAM 20 to recreate the original data words M processed by the data processing unit 30. In FIG. 1 and subsequently, M denotes an arbitrary unencrypted data word of width n, while M′ denotes an arbitrary encrypted data word of width n generated by encrypting a data word M.

FIG. 2 illustrates the structure of the encryption and decryption unit 10 in more detail. The unit 10 comprises an encryption unit 11 which has an input 110 of n-bit width to receive an unencrypted data word M, and an output 111 that provides an encrypted data word M′. Encryption of the data word M is performed as determined by a first key C which is provided by a key generator 13. To supply this first key C, a binary random sequence RS is fed by a binary random number generator 12 to the key generator 13.

The encryption/decryption unit 10 further comprises a decryption unit 11′ with an input 110′ to supply an encrypted data word M′ of n-bit width, and an output 111′ to supply the decrypted data word M generated from the encrypted data word M′. The decryption is performed as determined by a second key C′ which is matched to the first key C and which is also provided by the key generator 13.

The encryption unit 11 maps the data word M using the first key C uniquely to the encrypted data word M′, where:
M′=E(M,C) (1)

where E stands for the encryption function implemented by the encryption unit 11. Analogously:
M=D(M′,C′) (2)

where D stands for the decryption function implemented by the decryption unit 11′.

FIG. 3 illustrates in more detail an embodiment of the encryption unit 11 of FIG. 2 which in the example comprises a permutation unit 14 and a substitution unit 15. The permutation unit 14 has inputs to receive the individual data bits M[n−1] . . . M[0] of the data word M, and has outputs to supply data bits Mp[n−1], Mp[k], Mp[0] of a permutated data word Mp. The individual data bits Mp[n−1] . . . Mp[0] of the permutated data word Mp result from the data bits M[n−1] . . . M[0] of the data word M by permutation or rearrangement as determined by a permutation key P. The permutation may be performed on a one-to-one basis, that is, one data bit each of the unencrypted data word M is mapped to one data bit of the permutated data word Mp.

In the example, the data bits Mp[n−1] . . . Mp[0] of the permutated data word Mp are substituted by a substitution unit 15 as determined by a substitution key S, where the substitution unit 15 provides the data bits of the encrypted data word M′. As determined by the substitution key S, one data bit each of the permutated data word Mp is mapped by the substitution unit 15 to one data bit M′[n−1] . . . M′[0] of the encrypted data word M′.

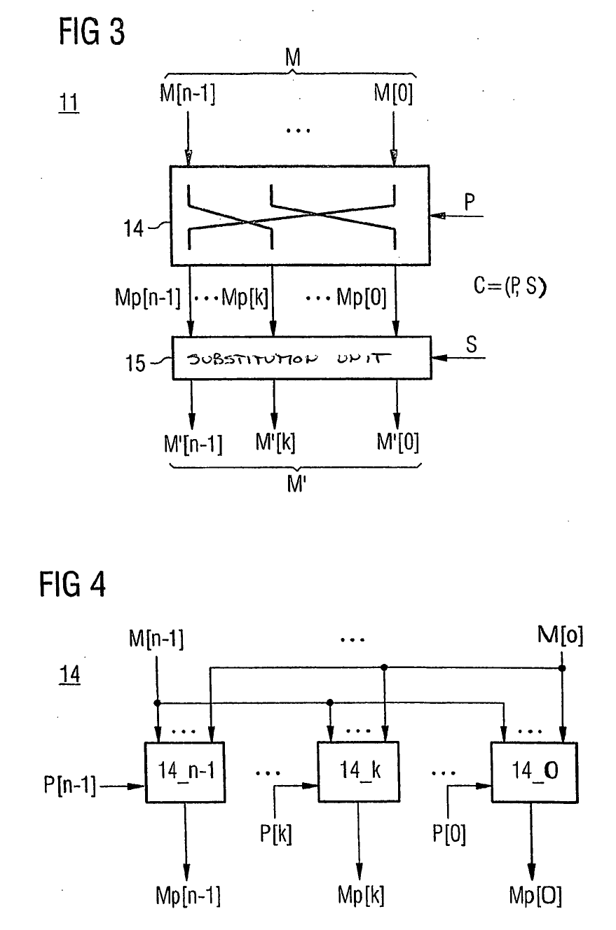

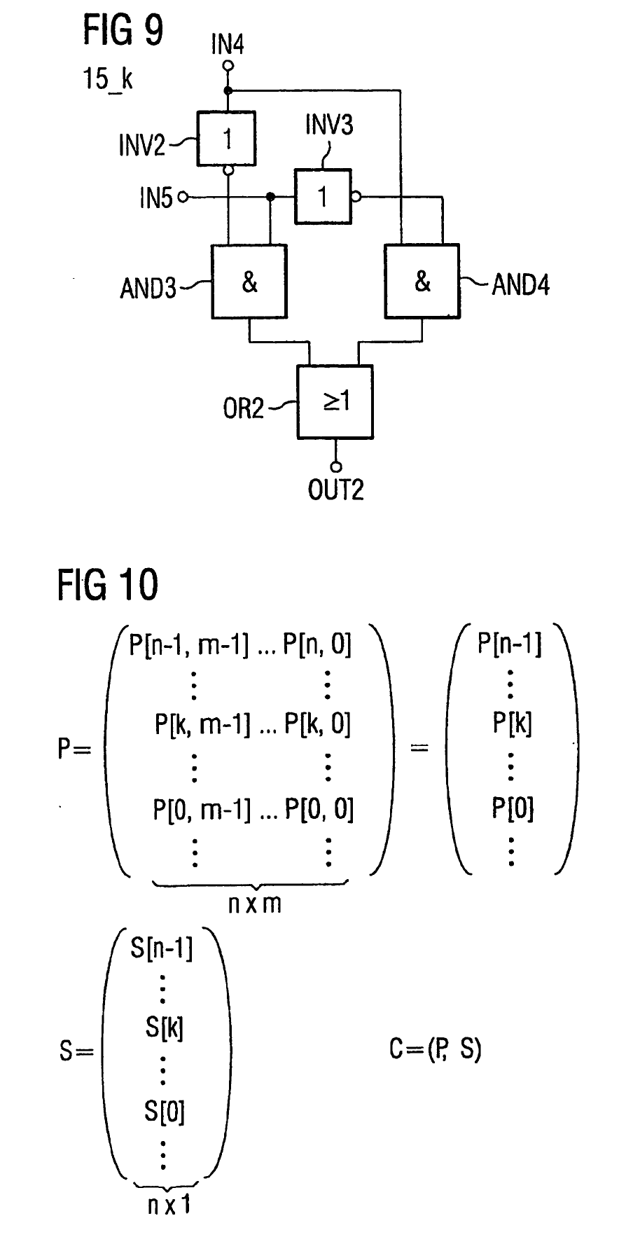

The following explains the structure and the functional principle of the permutation unit 14 with respect to FIGS. 4-7. Also, the structure and functional principle of the substitution unit 15 is explained with respect to FIGS. 8-9.

With reference to FIG. 4, the permutation unit 14 has a number of selection units 14_n−1 . . . 14_0 corresponding to the number of data bits of the data word M to be encrypted. All of the data bits M[n−1] . . . M[0] of the data word M to be encrypted are supplied to each of the selection units. The individual selection units 14_n−1 . . . 14_0 each provide a data bit Mp[n−1] . . . Mp[0] of the permutated data word Mp. Mapping of one of the data bits of the unencrypted data word M to one of the data bits of the permutated data word Mp is performed in the selection units 14_n−1 . . . 14_0 as determined by sub-permutation-keys P[n−1], P[k], P[0]. Each of the sub-permutation-keys differ to map each of the data bits of the input data word M exactly once to a data bit of the permutated data word Mp. The sub-permutation-keys together produce the permutation key P, where P=(P[n−1], . . . P[0]).

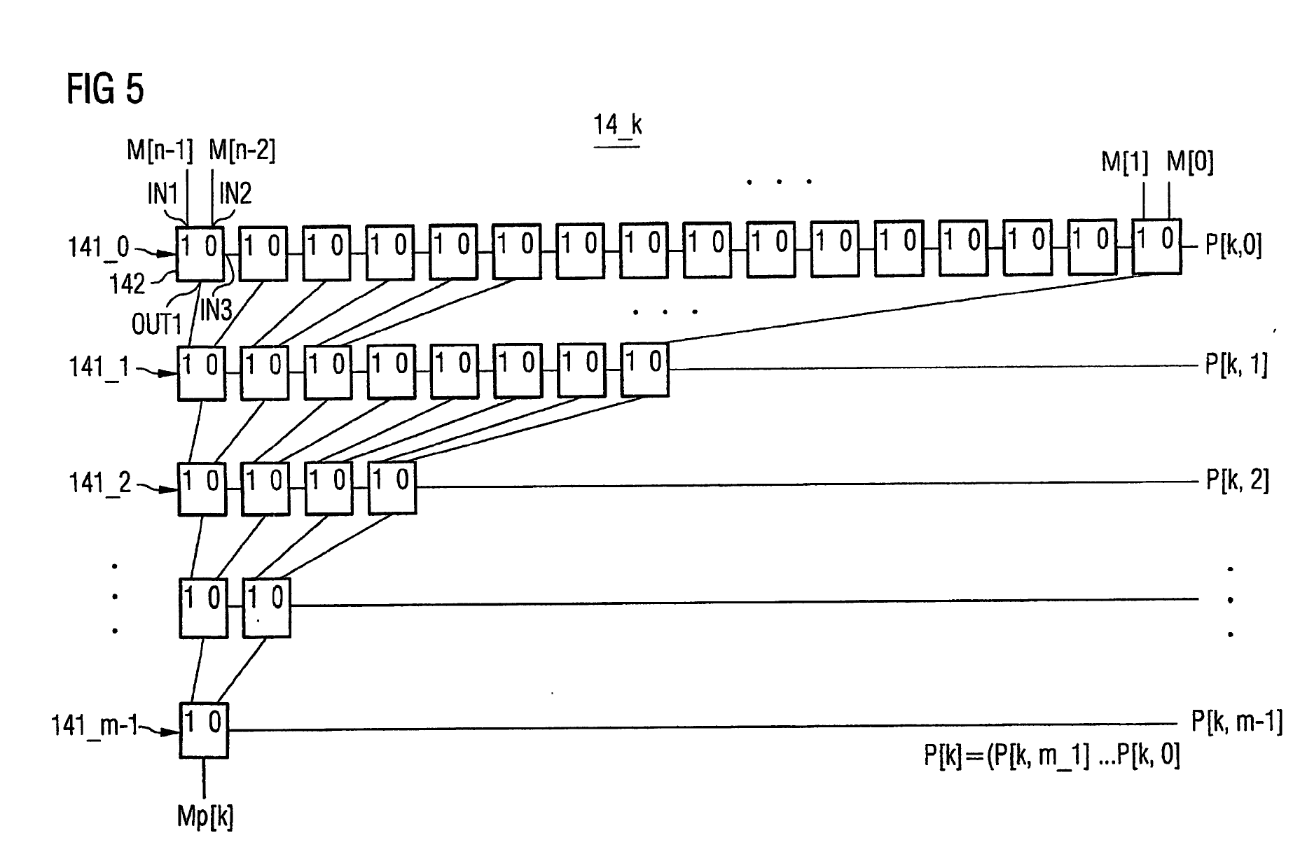

The individual selection units 14_n−1 . . . 14_0 are structured identically, the structure of one of the selection units, for example, the selection unit 14_k, explained below with respect to FIG. 5. The selection unit 14-k (FIG. 4) provides the data bit Mp[k] from the data bits M[n−1] . . . M[0] of the data word M as determined by the sub-permutation-key P[k], which comprises m key bits P[k,m−1] . . . P[k,0]. Referring to FIG. 5, the selection unit 14-k comprises multiple selection stages 141_0 . . . 141_m−1. All of the data bits of the input data word M are supplied to a first selection stage 141_0. As determined by a first key bit P[k,0] of the sub-permutation-key P[k], the first selection stage 141_0 selects a first group of data bits which are supplied to a second selection stage 141_1. As determined by a second key bit P[k,1], the second selection stage 141_1 generates from this first group of data bits a second group of data bits which is supplied to the third selection unit 141_2.

In the example illustrated in FIG. 5, reduction of the data bits present in the respective groups is performed from selection stage to selection stage by a factor of 2, such that after m=log₂ (n) selection stages only one data bit is left which corresponds to data bit Mp[k] of the permutated data word Mp. In this example in which n=32=2⁵, there are thus m=5 selection stages.

Also, in the example of FIG. 5, each of the selection stages comprises a number of selection switches 142, to which two data bits each of a data group are supplied, and which, as determined by a permutation key bit, select one of the two data bits and pass it on to the next selection stage. The supply of the individual data bits to the selection switches of each of the selection stages is performed such that two data bits each are supplied to a selection switch, which data bits have successive bit positions in relation to the group from which the selection stage has made a selection. In the example of FIG. 5, the respective higher-order bit is supplied to a first input IN1 of the selection switch 142, while the respective lower-order bit is supplied to a second input IN2 of the selection switch 142. In the example shown, for a key bit “1”, the bit applied at the input NIN is passed to output OUT1 and to the next selection stage.

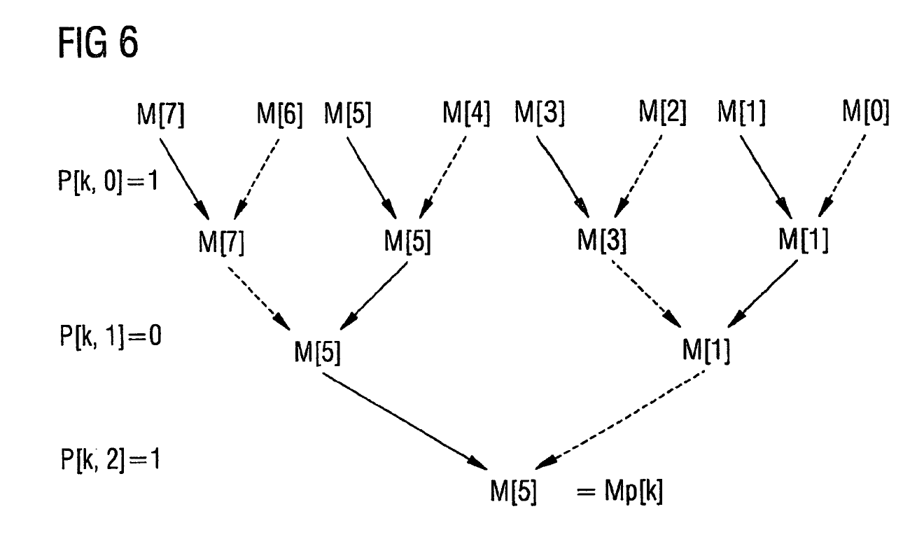

The functional principle of the selection stage illustrated in FIG. 5 is explained below based on an 8-bit-wide data word M with respect to FIG. 6. From these eight data bits M[7] . . . M[0], one bit is selected to generate the data bit Mp[k] of the permutated data word. The first key bit P[k,0] of the subkey P[k] has a value of 1 so that out of two data bits that are consecutive in terms of significance the higher-order data bit is selected, thus yielding a first group with data bits M[7], M[5], M[3], and M[1]. Out of each two consecutive data bits, in terms of their significance (i.e, data bits M[7], M[5] and M[3], M[1]), one data bit each is selected as determined by the second key bit P[k,1]. In the example, this key bit is “0”, so that in each case the lower-order one of the two data bits is selected, that is, data bits M[5], M[1]. Out of this resulting additional group of data bits, one data bit is selected, in this case the higher-order data bit M[5], as determined by the third key bit P[k,2] to generate the data bit Mp[k] of the permutated data word.

If the data bits in each of the selection groups are arranged as a function of their significance, and out of two adjacent ones in terms of their significance given a key bit “I” the higher-order data bit is selected, and given a key bit “0” the lower-order one of these two data bits is selected, then the value of the bit position of the selected data bit, in this case of data bit M[5], corresponds to the decimal equivalent of the subkey P[k], as explained below.

If the subkey P[k] is viewed as a binary numerical sequence, the most significant bit (MSB) of which is generated by the key bit P[k,m−1] of the last selection stage, and the least significant bit (LSB) of which is generated by key bit P[k,0] of the first selection stage, then the decimal equivalent of this binary sequence, in this case 101₂=5₁₀, corresponds to the bit position of the data bit M[5] selected from the data word M.

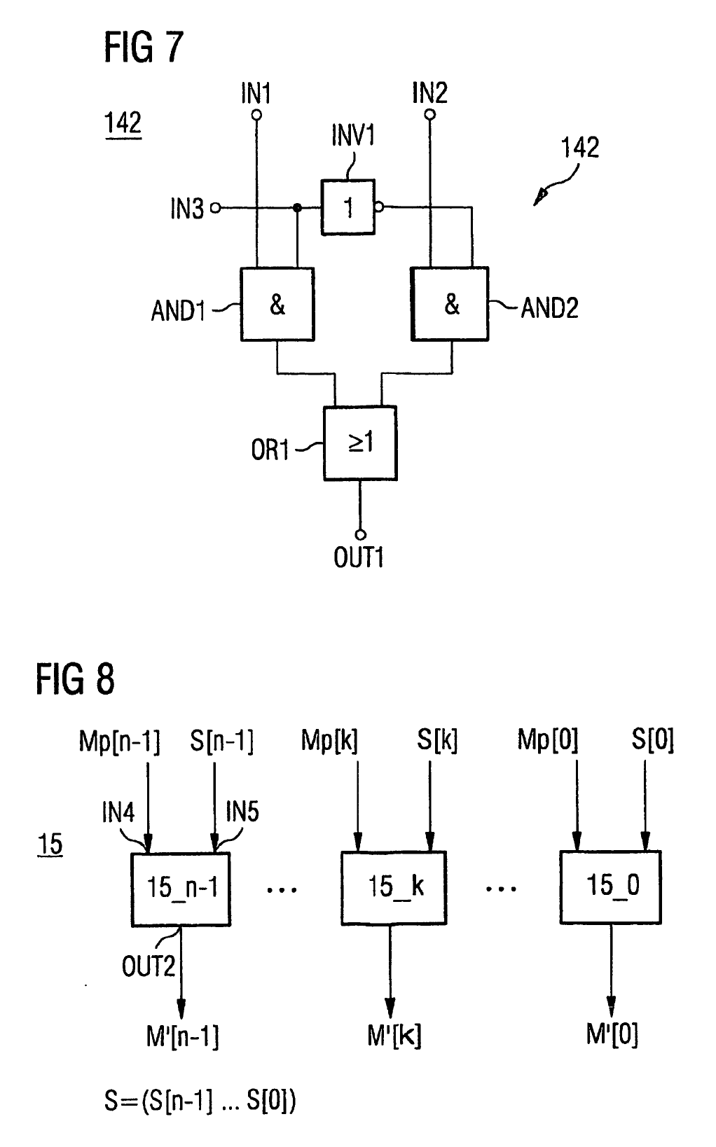

A circuit-logic implementation of one embodiment of one of the selection switches 142 is illustrated in FIG. 7. To implement the described selection function, the selection switch 142 comprises two AND gates, AND1, AND2, the outputs of which are supplied to an OR gate, OR1, where the output of this OR gate forms the output OUT1 of the selection switch 142. One each of the inputs IN1, IN2 to supply the data bits is supplied to one of the AND gates, AND1, AND2. The other input of the AND gate AND1 is coupled to the third input IN3 to supply a key bit, where this key bit is supplied in inverted form through an inverter INV1 to the other input of the AND gate AND2. When a logical “1” is applied at the third input IN3, the data bit applied at the first input IN1 is passed through the first AND gate bit ANDI and the OR gate OR1 to the output OUT1. Given a logical “0” at the third input IN3, the data bit at the second input IN2 is accordingly passed through the second AND gate AND2 and the OR gate OR1 to the output OUT1.

With reference to FIG. 8, the substitution unit 15 comprises a number of substitution elements 15_n−1 . . . 15_0 corresponding to the number of data bits. One data bit of the data word to be substituted is supplied to each of the substitution elements; in the example of FIG. 3, that of the permutated data word Mp. The substitution key S, on the basis of which the substitution is performed, comprises n key bits S[n−1] . . . S[0], where one of these key bits S[n−1] . . . S[0] is supplied to each of the substitution elements. The substitution elements 15_n−1 . . . 15_0 are designed, as determined by the respective substitution key bit S[n−1] . . . S[0], to output in unchanged or inverted form the data bit Mp[n−1] . . . Mp[0] supplied to the respective substitution element 15_n−1. . . 15_0.

A circuit-logic implementation of an embodiment of the substitution element 15 is illustrated in FIG. 9. The substitution element 15_k comprises first and second AND gates AND3, AND4, and an OR gate OR2 connected following the AND gates AND3, AND4. The output of the OR gate OR2 provides the substituted data bit. The substituted data bit is supplied to the substitution element through a first input IN4, and this data bit is supplied in inverted form by a first inverter INV2 to the first AND gate AND3, and in unchanged form to the second AND gate AND4. The respective substitution key applied at a second input IN5 of the substitution element is supplied to the first AND gate AND3 in unchanged form, and to the second AND gate AND4 in inverted form by a second inverter INV3. This arrangement ensures that given a substitution key bit “1” the data bit applied at the first input IN4 is provided in inverted form, and given a substitution key bit “0” this data bit is provided in unchanged form at the output OUT2.

In the embodiment of FIG. 3, the encrypted data word M′ is generated from the unencrypted data word M by permutation and subsequent substitution of the data word Mp resulting from the permutation. It is also possible first to substitute the data word M using the substitution key S, and then to permutate the resulting substituted data word using the permutation key P to arrive at the encrypted data word M′.

The determining factor for the efficacy of an encryption system is the number of different possible keys. In the example described, the key C to encrypt the data word M is composed of the permutation key P and the substitution key S. The permutation key P comprises a number of subkeys corresponding to the number of data bits, the width of the subkeys being defined by m=log₂(n). With reference to FIG. 10, the permutation key P can be viewed as a vector with n subkeys P[n−1] . . . P[0], or as an n×m matrix of individual subkey bits P[n−1, m−1] . . . P[0,0]. For data words of width n=32, the permutation key P comprises 32 different subkeys P[n−1] . . . P[0], thereby resulting in 32! different key combinations. Given that for the substitution key S there are 2ⁿ available possibilities, then for the number N possible keys C for data words to be encrypted of width n=32 the result is: N=(32!)·2³².

The substitution key S for encryption and decryption can be generated as part of a binary random sequence.

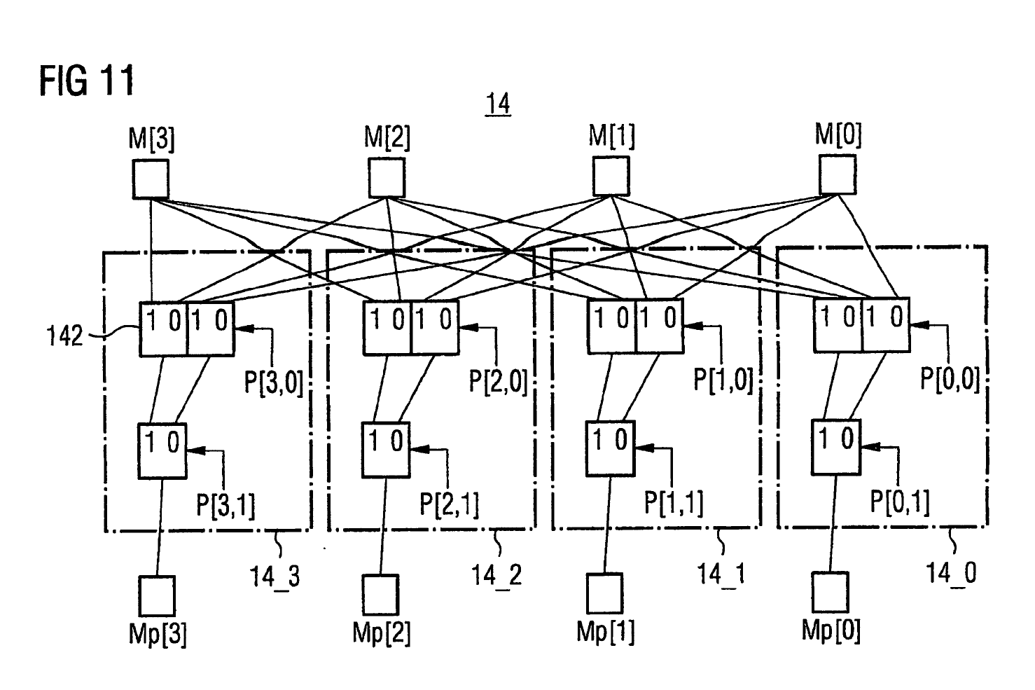

A method of generating the permutation key P is explained below for a data word of width n=4 bit based on FIGS. 11-13.

FIG. 11 illustrates a first permutation unit 14 that generates the permutated data word Mp from the data word M with n=4 selection units 14_3, 14_2, 14_1, 14_0 which are each of two-stage form (m=log₂ 4=2).

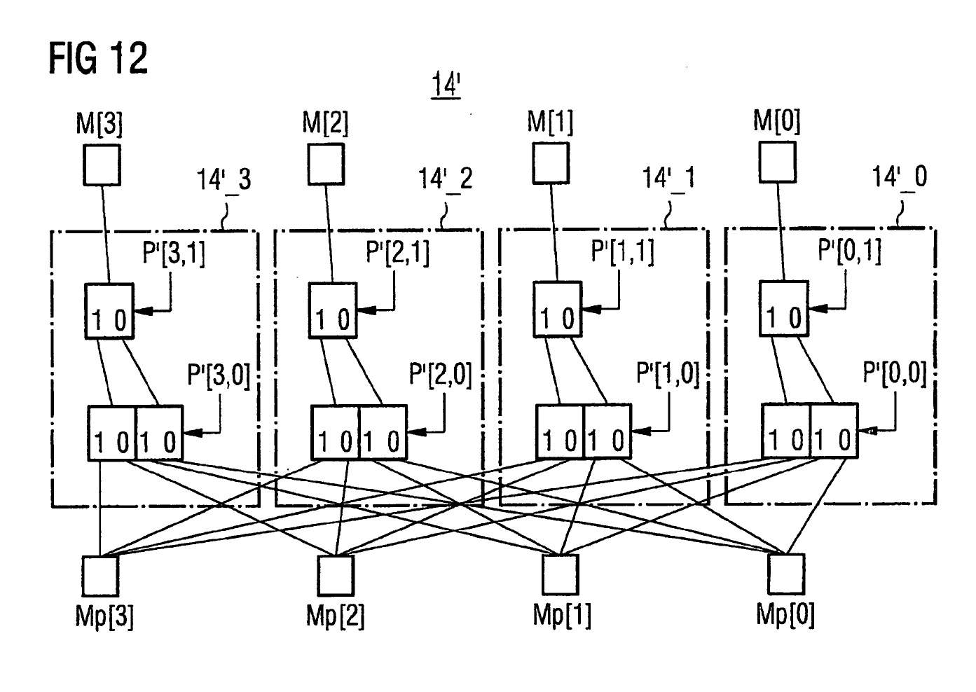

FIG. 12 illustrates a second permutation unit 14′ corresponding to the permutation unit 14 of FIG. 11 which functions to undo the permutation effected by the first permutation unit 14 as it decrypts the data word in the decryption unit 11 (FIG. 3). The second permutation unit 14′ is identical to the first permutation unit 14 in structure and comprises four selection units 14′_3, 14′_2, 14′_1, and 14′_0. Each of these selection units 14′_3 . . . 14′_0 functions to map one of the data bits Mp[3] . . . Mp[0] of the permutated data word Mp back to one of the data bits M[3] . . . M[0] of the original data word M. This selection of one of the data bits in the individual selection units 14′_3 . . . 14′_0 is performed in each case as determined by the subkeys P′[3] . . . P′[0] of a second permutation key P′. In the example illustrated, P′ =(P′[3], P′[2], P′[1], P′[0]), where the individual subkeys P′[3] . . . P′[0] each comprises two subkey bits P′[3,1] . . . P′[0,0].

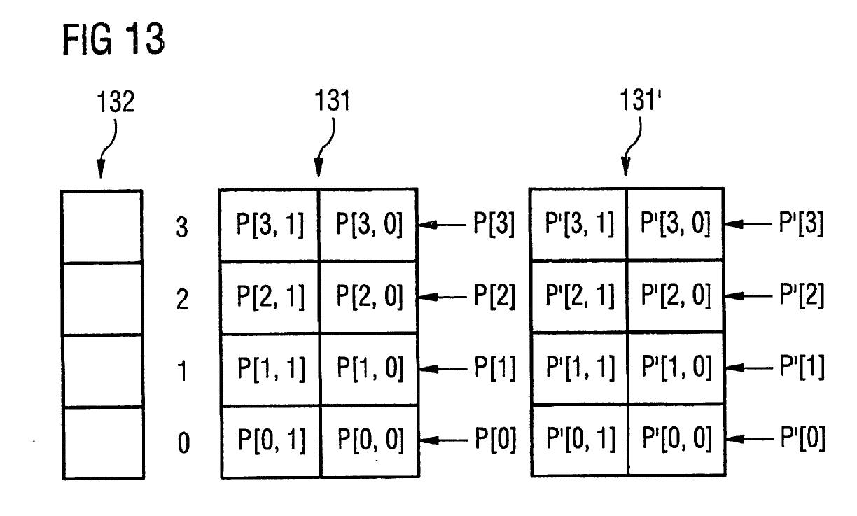

The generation of the subkeys P[3] . . . P[0] of the first permutation key P and of the associated subkeys P′[3] . . . P′[0] of the second permutation key P′ is explained based on FIG. 13. To generate the first and second permutation keys P, P′, the key generator 13 (FIG. 2) comprises a first and second key memory 131, 131′, as well as an assignment register 132. The key memories 131, 131′ each store n subkeys of key width m=log₂(n). Given n=4, four subkeys of width 2 are storable in each of the key memories 131, 13 1′. Assignment of the subkeys stored in the first key memory 131 to the selection units 14_3 . . . 14_0, and thus to the individual data bits of the permutated data word Mp, is performed through the address of the key memory 131 which is addressable line-by-line and which in the example comprises n=4 lines. The memory address of a subkey in the first key memory 131 corresponds to the bit position of the data bit of the permutated data word to which the respective key is assigned. A subkey P[k] at the memory address k of the key memory 131 is thus assigned to the k^{th} data bit Mp[k] of the permutated data word Mp, where k represents one of the possible line addresses 0 . . . n−1 of the memory.

Assignment of subkeys P′[3] . . . P′[0] of the second subkey P′ to the selection units 14′_3 . . . 14′_0 or to the data bits M[3] . . . M[0] of the original data word is performed analogously. That is, the subkey P′[k] stored at the memory position k of the second key memory 131 is assigned to the selection unit 14′_k and determines which of the data bits of the permutated data word Mp is to be mapped to the data bit M[k] at the k^{th} position of the data word M.

Generation of the subkeys P[3] . . . P[0] of the first permutation key and of the second subkeys P′[3] . . . P′[0] is performed in a mutually matched fashion by a procedure explained below.

The subkeys of the first permutation key P are generated consecutively as random binary sequences of width m=2 using the function generator 12 illustrated in FIG. 2. As explained, the individual subkeys differ from one another to obtain a one-to-one assignment of the data bits of the data word M to be permutated to the data bits of the permutated data word Mp. In the example described based on FIGS. 11 and 12, there are n=4 different subkeys which can be assigned randomly to the four selection units.

One memory position of the assignment register 132 is assigned to each of the possible different subkeys, in this case, “11”, “10”, “01”, “00”. A predetermined value is entered in the assignment register 132 at the respective position if the assigned subkey has already been generated at a memory position of the memory 131, and thus for one of selection units 14_3 . . . 14_0, to avoid generating the same key at a different memory address, and thus for another selection unit 14_3 . . . 14_0.

In the example, the assignment of a certain one of the possible subkeys to a memory address of the assignment register 132 is performed by directly mapping the value represented by the subkey to the address of the memory position of the assignment register 132. For example, the memory position 102=2 of the assignment register 132 is thus assigned to a subkey “10”. If P[k]=wₙ₋₁ . . . w₀ applies for a subkey, then for the address assigned to this subkey:

$$W = {\sum }_{i = 0}^{i = n - 1} {w}_{i} {2}^{i}$$

To generate the permutation key, the respective subkeys are randomly generated consecutively for the individual memory addresses of the first permutation key memory 131, where after generation of a given subkey a determination is made based on examination of the assignment register whether such a subkey has already been generated. If such a subkey has already been generated, the subkey is rejected and a new subkey is randomly generated. This procedure is repeated until subkeys have been generated for all the memory positions, and thus for all the selection units of the permutation unit 14.

When one of the possible subkeys is generated for the first time, a certain value, for example a “1,” is entered at the memory address, assigned to this key, of the assignment register 132. If this subkey is randomly generated once again for another memory position of the memory 131, this is detected in the assignment register 132 based on the value entered, and the subkey is rejected for this different memory position.

As explained above, the binary value of a subkey P[3] . . . P[0] which is assigned to a selection unit 14_3 . . . 14_0 or to a data bit Mp[3] . . . Mp[0] of the permutated data word Mp corresponds to the data position of the data bit M[3] . . . M[0] of the input word M selected by the respective selection unit. Accordingly, the subkeys P′[n−1] . . . P′[0] of the second permutation key P′ each indicate which of the data bits of the permutated data word Mp is to be mapped to the data bit M[3] . . . M[0] to which the respective subkey is assigned.

If the general condition applies that a subkey P[k] assigned to the k^{th} data bit Mp[k] of the permutated data word Mp maps the i^{th} data bit M[i] of the permutated data word to this data bit of the permutated data word Mp, then, conversely, the subkey P′[i] assigned to the i^{th} data bit must map the k^{th} data bit of the permutated data word Mp to this data bit.

The second key memory 131′ is organized analogously to the first key memory 131. That is, the addresses at which the individual subkeys P′[n−1] . . . P′[0] are stored correspond to the bit positions of the data bits M[n−1 . . . M[0] to which the individual subkeys are assigned.

To generate a matching subkey of the second permutation key P′ for a randomly generated subkey P[k] of the first permutation key P, which subkey is assigned to the k^{th} data bit of the permutated data word Mp, the address value k of the first subkey P[k] is entered at the address in the second key memory 131′, the value of which corresponds to the binary value i represented by the first key, that is, for P[k]=i, P′[i]=k.

Generation of the first and second permutation keys can be performed by the following routine:
Line 1: FOR k=(n−1) DOWNTO 0
Line 2: Fetch random number from generator and compute i
Line 3: Check if MapReg (i)=1, if true, go to Line 2
Line 4: Set MapReg(i)=1
Line 5: Set o_store(k)=i
Line 6: Set i_store(i)=k
Line 7: NEXT k.

MapReg(i) here represents the value at address k of the assignment register 132. The expression o_store(k) represents the value at address k of the first memory 131, while i-store(i) represents the value at address i of the second memory 131′.

As explained above, the permutation performed during encryption and analogously during decryption is augmented by a substitution as determined by a substitution key. This substitution can be performed either before the permutation or after the permutation, the procedure being performed in the reverse order during the decryption. If during encryption the substitution is performed after the permutation, then during decryption the re-substitution is performed before the permutation. During the above-described substitution in which, as determined by the substitution key bits, the respective assigned data bit is passed on either inverted or unchanged, the same substitution key used during decryption is used during encryption.

Although the present invention has been illustrated and described with respect to several preferred embodiments thereof, various changes, omissions and additions to the form and detail thereof, may be made therein, without departing from the spirit and scope of the invention.

What is claimed is:

1. A method of storing encrypted data in a random aceess memory, comprising the steps of:
encrypting data word by permutating each data bit of the data word using a permutation key to generate permutated data word, and
storing the permutated data word in the memory.

2. The method of claim 1, where after the step of permutating, further comprising the step of substituting each data bits of the permutated data word using a substitution key to generate a substitute data word, and where the step of storing comprises the step of storing the substitute data word in the memory.

3. The method of claim 1, where the step of encrypting further includes the step of substituting each data bit of the unencrypted data word using a substitution key prior to the step of permutating to generate a substitute data word, and where the step of permutating comprises the step of permutating each data bit of the substitute data word using the permutation key to generate the permutated data word.

4. The method of claim 1, where the permutation key includes a plurality of subkeys corresponding to the number of the data bits of the data word, and where each one of the subkeys includes a plurality of key bits where the step of permutating each data bit in the data word using a permutation key further comprises the steps of:
assigning each one of the subkeys to a corresponding one of the data bits of the permutated data word: and
mapping each data bit of the unencrypted data word to a corresponding one of the data bits of the permutated data word using the corresponding assigned subkey.

5. The method of claim 4, where the step of mapping comprises:
a) selecting a first group of the data bits of the data word determined by a first one of the plurality of key bits of the corresponding assigned subkey;
b) selecting a second group of the data bits of the data word from the first group of the data bits as determined by a second one of the plurality of key bits of the corresponding assigned subkey; and
c) repeating step b), each time using an additional one of the plurality of key bits of the corresponding assigned subkey until there exists one remaining data bit of the data word, where the one remaining data bit corresponds to the data bit ofthe data word mapped to ethe corresponding data bit of the permutated data word.

6. The method of claim 5, where the number of data bits in the second group of the data bits of the data word is reduced b a factor of two from the number of data bits in the first group of the data bits of the data word, and where the number of data bits in each group of the data bits of the data word in each iteration of step c is reduced by a factor of two.

7. The method of claims 2, where the substitution key includes a plurality of key bits corresponding to the number of data bits of the permutated data word, where the step of substituting each data bit of the permutated data word using a substitution key further comprises the step of mapping each data bit of the permutated data word to a data bit of the substituted data word in one of an unchanged form and an inverted form as determined by the corresponding one of these key bits.

8. The method of claim 3, where the substitution key includes a plurality of key bits corresponding to the number of data bits of the data word, where the step of substituting each data bit of the data word using a substitution key further comprises the step of mapping each data bit of the data word to a data bit of the substituted data word in one of an unchanged form and an inverted form as determined by the corresponding one of the key bits.

9. The method of claim 1, further comprising the step of generating the permutation key by the the following steps:
a) randomly generating a sub-permutation-key and assigning the generated sub-permutation-key to a data bit position of the permutated data word;
b) checking whether the generated sub-permutation-key has already been assigned to a data bit of the permutated data word, and retaining the generated sub-permutation-key as the assigned sub-permutation-key if the generated sub-permutation key has not yet been assigned to a data bit of the permutated data word; and
c) implementing steps a) and b) until a sub-permutation-key is assigned to each data bit of the permutated data word.

10. The method of claim 1, further comprising the step of decrypting the stored permutated data word using a second permutation key matched to the permutation kev used to generate the permutated data word.

11. A device that encrypts and decrypts a data word having a predetermined number of data bits, the device having a permutation unit comprising:
a plurality of data inputs that receive the data bits of the data word; and
a plurality of selection units corresponding to the number of data bits of the data word, where each one of the selection units is responsive to a subkey portion of a permutation key, where each one of the selection units provides one data bit each of a permutated data word from the corresponding data bit of the data word as determined by the corresponding one of the subkeys.

12. The device of claim 11, where each selection units comprises number of consecutively arranged selection stages corresponding to a number of permutation key bits of the corresponding subkey for that selection unit, where a first selection stage is responsive to a first one of the permutation key bits to select and provide a first group of data bits of the data word, and where subsequent ones of the selection stages are each responsive to subsequent ones of the permutation key bits to select a subgroup of the data bits from a group of data bits of the data word provided by the respective previous selection stage.

13. The device of claims 11, further comprising a a substitution unit connected after the permutation unit, that substitutes each data bits of the permutated data word in response to a substitution keys.

14. The device of claim 11, further comprising a substitution unit connected before the permutation unit, that substitutes each data bit of the data word in response to a substitution key.

15. A method of storing encrypted data in a memory, comprising the steps of:
encrypting a data word by permutating each data bit of the data word using a permutation key to generate a permutated data word;
substituting each data bit of the permutated data word using a substitution key to generate a substitute data word; and
storing the substitute data word in the memory.

16. The method of claim 15, where the permutation key includes a plurality of subkeys corresponding to the number of the data bits of the unencrypted data word, and where each one of the subkeys includes a plurality of key bits, where the step of permutating each data bit further comprises the steps of:
assigning each one of the subkeys to a corresponding one of the data bits of the permutated data word; and
mapping each data bit of the data word to a corresponding one of the data bits of the permutated data word using the corresponding assigned subkey.

17. The method of claim 16, where the step of mapping comprises the following steps:
a) selecting a first group of the data bits of the data word as determined by a first one of the plurality of key bits of the corresponding assigned subkey;
b) selecting a second group of the data bits of the data word from the first group of the data bits as determined by a second one of the plurality of key bits of the corresponding assigned subkey; and
c) repeating step b), each time using an additional one of the plurality of key bits of the corresponding assigned subkey until there exists one remaining data bit of the data word, where the one remaining data bit corresponds to the data bit of the data word mapped to the corresponding data bit of the permutated data word.

18. A method of storing encrypted data in a memory, comprising the steps of:
substituting each data bit of an unencrypted data word using a substitution key to generate a substitute data word; and
permutating each data bit of the substitute data word using a permutation key to generate a permutated data word;
storing the permutated data word in the memory.

19. The method of claim 18, where the permutation key includes a plurality of subkeys corresponding to the number of the data bits of the substitute data word, and where each one of the subkeys includes a plurality of key bits, where the step of permutating each data bit further comprises the steps of:
assigning each one of the subkeys to a corresponding one of the data bits of the substitute data word; and
mapping each data bit of the substitute data word to a corresponding one of the data bits of the permutated data word using the corresponding assigned subkey.

20. The method of claim 19, where the step of mapping comprises the following steps:
a) selecting a first group of the data bits of the substitute data word as determined by a first one of the plurality of key bits of the corresponding assigned subkey;
b) selecting a second group of the data bits of the substitute data word from the first group of the data bits as determined by a second one of the plurality of key bits of the corresponding assigned subkey; and
c) repeating step b), each time using an additional one of the plurality of key bits of the corresponding assigned subkey until there exists one remaining data bit of the substitute data word, where the one remaining data bit corresponds to the data bit of the substitute data word mapped to the corresponding data bit of the permutated data word.
